(19) United States
(12) Patent Application Publication
(10) Pub. No.: US 2012/0273080 A1
(43) Pub. Date: Nov. 1, 2012

(54) FLEXIBLE PIPE AND A METHOD OF PRODUCING A FLEXIBLE PIPE

(75) Inventors: Kristian Glejbøl, Glostrup (DK); Rasmus C. Østergaard, Copenhagen O (DK)

(73) Assignee: NATIONAL OILWELL VARCO DENMARK I/S, Brondby (DK)

(21) Appl. No.: 13/515,362

(22) PCT Filed: Dec. 3, 2010
(86) PCT No.: PCT/DK10/50330

§ 371 Date: Jul. 16, 2012

(30) Foreign Application Priority Data
Dec. 16, 2009 (DK) PA 2009 01332

(51) Int. Cl. F16L 11/00

(52) U.S. Cl. 138/137

(57) ABSTRACT

The invention relates to a flexible pipe. Such flexible pipe has a length and comprises a tubular inner sealing sheath surrounding an axis and defining a bore; at least one pressure armor and at least one tensile armor comprising one or more layers. The pressure armor and the tensile armor are non-bonded relative to each other. In the flexible pipe of the invention, the pressure armor comprises a sandwich structure comprising a polymer structure and a first and a second strength imparting layer arranged on either side of said polymer structure and locked or bonded to the polymer structure.

The flexible pipe has a high strength and can be manufactured in a cost effective manner.

### TECHNICAL FIELD

The invention relates to a flexible pipe in particular for transportation of hydrocarbons and or water and/or for an umbilical as well as a method for producing such pipe.

### BACKGROUND ART

Flexible pipes of the present type are well known in the art in particular for offshore transportation of fluids. Such pipes usually comprise an inner liner often referred to as an inner sealing sheath or an inner sheath, which forms a barrier against the outflow of the fluid which is conveyed through the pipe, and one or more armoring layers on the outer side of the inner liner (outer armoring layer(s)). An outer sheath may be provided with the object of forming a barrier against the ingress of fluids from the pipe surroundings to the armor layers.

Typical unbonded flexible pipes are e.g. disclosed in WO0161232A1, U.S. Pat. No. 6,123,114 and U.S. Pat. No. 6,085,799.

In order to have sufficient strength, in particular to prevent the collapse of the inner sealing sheath, the flexible pipe often comprises an armor layer located inside the space defined by the inner sealing sheath. Such inner armoring layer or layers are normally referred to as a carcass.

The flexible pipes are often unbonded pipes. As used in this text the term “unbonded” means that at least two of the layers including the armoring layers and polymer layers are not bonded to each other. In practice the known pipe normally comprises at least two armoring layers located outside the inner sealing sheath. In the prior art unbonded pipes, the armoring layers are not bonded to each other or to other layers directly or indirectly via other layers along the pipe.

The pipe layers can therefore move relative to each other, and thereby the pipe becomes bendable, usable for dynamic applications e.g. as risers, and sufficiently flexible to roll up for transportation even when the layers are relatively thick, which is necessary for high strength pipes which should be able to withstand high pressure differences over layers of the pipe e.g. pipe differences between the pressure inside the bore of the pipe and the pressure on the outer side of the pipe.

The above-mentioned type of flexible pipes is used, among other things, for off-shore as well as some on-shore applications for the transport of fluids and gases. Flexible pipes can e.g. be used for the transportation of fluids where very high or varying water pressures exist along the longitudinal axis of the pipe, such as riser pipes which extend from the seabed up to an installation on or near the surface of the sea, pipes for transportation of liquid and gases between installations, pipes which are located at great depths on the seabed, or between installations near the surface of the sea.

In traditional flexible pipes, such as steel based flexible pipes i.e. where the armoring layers are mainly of steel, the armoring layers are usually in the form of helically wound profiles or wires, where the individual layers may be wound with different winding angles relative to the pipe axis in order to take up the forces caused by internal and external pressure as well as forces acting at the ends of the pipe and forces from the surrounding water. The carcass is typically wound from preformed or folded stainless steel strips.

For many applications a pipe of the above type will need to fulfill a number of requirements. First of all the pipe should have a high mechanical strength to withstand the enormous forces it may be subjected to during transportation, laying down and in operation. The internal pressure (acting from inside of the pipe and outwards) and the external pressure (acting from outside of the pipe to the outer surface of the pipe) are very high and may vary considerably along the length of the pipe. If the pipe resistance against the internal pressure is too low the internal pressure may ultimately result in that the pipe is damaged e.g. by upheaval buckling and/or burst of the flexible pipe. If the pipe resistance against the external pressure is too low the external pressure may ultimately result in deformation and/or Birdcaging of the flexible pipe and/or collapse of the inner sealing sheath which is acting as the primary barrier towards outflow of a fluid transported in the flexible pipe.

Also, it is desired that the weight of the pipe is kept sufficiently low because a too high weight may render certain use impossible or very costly in production of the pipe and/or in installation of the pipe.

In order to reduce weight, composite pipes without steel armoring have been developed. The cost of the material of such composite material without metal is however rather high, and furthermore the durability of such composite pipes has not been verified and for most deep water applications such composite pipes are not accepted by the oil companies.

The object of the invention is to provide a flexible pipe, which pipe can be provided in continuous lengths with a desired strength sufficient for deep water applications and which pipe can be manufactured in a cost effective manner.

The present invention provides a novel flexible pipe and a method for its production which meet this object. The flexible pipe of the invention and embodiments thereof have shown to have a large number of advantages which will be clear from the following description.

### DISCLOSURE OF INVENTION

The flexible pipe of the invention is as defined in the claims. According to the invention a new type of flexible pipes has been provided. The flexible pipe of the invention comprises an axis and a tubular inner sealing sheath surrounding said axis, said inner sealing sheath is surrounded by at least one outer armoring layer.

The inner sealing sheath has an inner side which is the side of the inner sealing sheath facing said axis. In other words all that is surrounded by the inner sealing sheath is on the inner side of the inner sealing sheath.

In the following the term “length of the pipe” is used to mean the length along the axis of the pipe. The space inside the inner sealing sheath is also referred to as the bore of the pipe.

The terms “axial direction” or “axially” are used to mean the direction along the length of an axis of the pipe. The term “substantially axial direction” means the direction along the length of an axis of the pipe +/−10 degrees.

Generally it is desired that the flexible pipe is substantially circular in cross sectional shape, however, it should be understood that the flexible pipes could have other cross sectional shapes such as oval, elliptical or slightly angular (angular with rounded edges). The axis of the flexible pipes may in such situations be determined as the most central axis in the bore of the flexible pipe.

The term “circumferential direction” means the direction following the circumference of the flexible pipe. The term “substantial circumferential direction” means the direction following the circumference of the flexible pipe in a plane perpendicular to the axis +/−10 degrees.

The terms “outside” and “inside” a member and/or a layer are used to mean outside, respectively inside said member and/or a layer in radial direction from, and perpendicular to the axis of the pipe and radially out to an outermost surface of the pipe.

The terms “tensile armor” and “pressure armor” are well recognized terms within the art of flexible pipes. A “tensile armor” means an armor arranged around the pipe to mainly absorb tensile forces, i.e. forces acting in axial direction and a “pressure armor” “means an armor arranged around the pipe to mainly absorb pressure forces i.e. forces acting in radial direction.

The flexible pipe of the invention should preferably be at least about 50 meters, such as at least about 500 meters, such as at least about 1000 meters, such as at least about 2000 meters or more, said annular armoring members being arranged along at least a part of the length of the flexible pipe.

Due to the unique structure of the flexible pipe of the invention the flexible pipe may in practice be even longer, since it can be produced with an optimized strength/weight profile such that it may be applied at depths which have not been possible with prior art pipes. A main reason for this is that the deeper a flexible pipe is to be used, the higher the requirement will be to strength against collapsing due to external hydrostatic pressure. The higher the strength that needs to be provided, the higher the weight of the pipe will be. The higher weight the more difficult transportation and installation, and in practice installation of a too heavy flexible pipe is impossible since the flexible pipe will be torn apart before the flexible pipe has been finally installed. In particular in situations where the flexible pipe is a riser pipe for transporting fluids in vertical direction e.g. from seabed to a sea surface installation such as a ship or a platform, the pull provided in the uppermost part of the pipe due to the heavy weight of the vertically extending pipe will tear and damage the pipe of prior art constructions.

Also during installation of flow lines at deep waters the pull in the uppermost part of the pipe during installation of prior art flexible pipes often results in damage of the flexible pipes or the flexible pipe needs to be over dimensioned in strength (which additionally adds to the weight as well as cost) in order to withstand the forces.

The flexible pipe of the invention has a length and comprises a tubular inner sealing sheath surrounding an axis and defining a bore. The flexible pipe comprises at least one pressure armor and at least one tensile armor comprising one or more layers and the pressure armor and the tensile armor are non-bonded relative to each other.

The term “non-bonded” is used herein to mean that the non-bonded layer can move relative to each other in at least substantial circumferential direction and preferably also in other directions including axial direction.

In other words, the pressure armor and the tensile armor are not bonded to each other and can move relative to each other at least in substantial circumferential direction.

The tensile armor may be as any tensile armor layers as described in prior art publications for example be in the form of wound wires e.g. as described in U.S. Pat. No. 5,176,179 and/or U.S. Pat. No. 5,813,439. In most situations the flexible pipe will comprise at least one layer, such as two layers of tensile armor e.g. a pair of cross wound tensile armouring layers made from wound wires. Typically the tensile armouring layer will have angles below 55 degree. In one embodiment the flexible pipe comprises one armor layer helically wound with an angle of between 60 and 75 degrees, and one helically wound tensile armouring layer with an angle below 55 degree, typically between 30 and 45 degrees.

Preferably anti-wear layer or layers are applied between the tensile armoring layers and the pressure armoring layer. Anti wear layers are well known in the art and are e.g. described in recommended Practice for Flexible Pipe API 17B, March 2002.

The pressure armor comprises a sandwich structure comprising a first and a second strength imparting layer arranged on either side of a polymer structure and locked or bonded to said polymer structure. In a preferred embodiment at least one of the first and the second strength imparting layers being a metal layer.

The strength imparting layers each have a higher material strength than the polymer structure compared to their weight. Preferably the strength imparting layers each are stronger than the polymer structure.

The term “locked” is used herein to mean locked against relative movement between two layers in at least one direction but not in all directions. In other words, the at least one strength imparting layer is locked to the polymer structure such that the at least one strength imparting layer and the polymer structure cannot move relative to each other in substantially circumferential direction, but they may be able to move relative to each other directions including substantially axial direction and the substantially circumferential direction. In a preferred embodiment at least one strength imparting layer is locked to the polymer structure such that the at least one strength imparting layer and the polymer structure cannot move relative to each other in substantially circumferential direction.

The term “bonded” is used herein to mean fixed to each other. In other words, the at least one strength imparting layer is bonded to the polymer structure such that the at least one strength imparting layer and the polymer structure cannot move relative to each in any directions.

The polymer structure may be a single layered structure or a multi layer bonded polymer structure.

In one embodiment the polymer structure is substantially uniform along the length of the pipe, thereby the polymer structure is simple to form e.g. by extrusion, and furthermore it is beneficial that the strength of the polymer structure will be uniform as well. However, in another embodiment the polymer structure varies more or less along the length of the pipe. In this embodiment the polymer structure may for example be provided by winding one or more film strips and/or one or more profiles.

The term profile is generally used to mean an elongate material element with a thickness and width of at least about 1 mm.

In one embodiment the polymer structure is a single layered structure, preferably of a substantially homogeneous polymer with a tensile strength at break of at least about 1 MPa, such as at least about 3 MPa.

In one embodiment the flexural modulus of the single layered polymer structure is in the interval from about 0.1 to about 20 GPa.

In one embodiment the polymer structure comprises a multi layer bonded polymer structure comprising at least 2 bonded layers, such as at least 3 bonded layers. The layers may be bonded in any way e.g. as it is known from prior art bonded pipes. The layers may be bonded prior to application on the pipe or they may be bonded after being applied to the pipe.

In one embodiment the polymer structure comprises a multi layer bonded polymer structure comprising a layer of a relatively hard material and a layer of a relative soft material. In one embodiment the polymer structure comprises a multi layer bonded polymer structure comprising a layer of a relatively hard material sandwiched between layers of a relatively soft material. The relatively soft material may for example have a shore D hardness which is at least about 5 shores lower than the relatively hard material. The relatively soft material provides a better grip for mechanical bonding to the strength imparting layers, while simultaneously the total strength of the polymer structure can be optimized by selecting of the relatively hard material. Preferably the relatively hard material layer has a thickness which is higher than the one or more layers of relatively soft material.

In one embodiment the polymer structure comprises a multi layer bonded polymer structure comprising at least one film layer, such as a polymer film layer with a thickness of from about 25 μm to about 1 mm. The film layer may for example constitute a layer of a relatively soft material.

In one embodiment the polymer structure comprises a multi layer bonded polymer structure comprising at least one film layer which has a lower permeability to one or more of the fluids methane, hydrogen sulphides, carbon dioxides and water, which is higher, such as least 50% higher, such as least 100% higher, such as least 500% higher, such as least 1000% higher, than the fluid permeation barrier provided by another layer of the multi layer bonded polymer structure determined at 50° C. and a pressure difference of 50 bar. In this embodiment the barrier properties can be optimized while optimizing other properties by selecting of other layers of the multi layer bonded polymer structure.

In order to provide a good strength of the pressure armor compared to its weight it is desired that the polymer structure has a total thickness of at least about 2 mm, such as at least about 4 mm, the polymer structure preferably has a total thickness of at least about ¼ of the total thickness of the pressure armor, such as at least about ⅓ of the total thickness of the pressure armor, such as at least about ½ of the total thickness of the pressure armor, such as at least about ⅔ of the total thickness of the pressure armor, such as at least about ¾ of the total thickness of the pressure armor.

In a preferred embodiment the polymer structure has a thickness which is at least as high as the thinnest of the strength imparting layers. The polymer structure may in one embodiment be substantially thicker, such as up to about 30 times thicker than the thickest of the strength imparting layers. In general the polymer structure should not exceed a thickness of about 20 mm; preferably the polymer structure can be up to about 16 mm, such as up to about 10 mm. In preferred embodiments the polymer structure is from about 4 mm to about 16 mm.

The polymer structure may in principle comprise any types of polymer material with a sufficient strength such as the polymers mentioned below as examples and other polymers with comparable strength. Examples of polymer(s) of the polymer structure comprise one or more of the materials selected from polyolefins, e.g. polyethylene or poly propylene; polyamide, e.g. poly amide-imide, polyamide-11 (PA-11), polyamide-12 (PA-12) or polyamide-6 (PA-6)); polyimide (PI); polyurethanes; polyureas; polyesters; polyacetals; polyethers, e.g. polyether sulphone (PES); polyoxides; polysulfides, e.g. polyphenylene sulphide (PPS); polysulphones, e.g. polyarylsulphone (PAS); polyacrylates; polyethylene terephthalate (PET); polyether-ether-ketones (PEEK); polyvinyls; polyacrylonitrils; polyetherketoneketone (PEKK); copolymers of the preceding; fluorous polymers e.g. polyvinylidene diflouride (PVDF), homopolymers or copolymers of vinylidene fluoride (“VF2”), homopolymers or copolymers of trifluoroethylene (“VF3”), copolymers or terpolymers comprising two or more different members selected from VF2, VF3, chlorotrifluoroethylene, tetrafluoroethylene, hexafluoropropene, or hexafluoroethylene; polymer blends comprising one or more of the above mentioned polymers and composite materials, such as a polymer (e.g. one of the above mentioned) compounded with reinforcement fibers, such as glass-fibers, carbon-fibers and/or aramide fibers.

In one embodiment the polymer structure is liquid pervious. In this embodiment the polymer structure is an internal liquid pervious sheath arranged on the inner side of the inner sealing sheath, an intermediate liquid pervious polymer structure or an outer liquid pervious sheath arranged on the outer side of the inner sealing sheath. The liquid pervious polymer structure may for example be a wound structure, such as a wound structure of one or more films and/or one or more profiles. The polymer structure may e.g. be liquid pervious in that liquid can pass the polymer structure via the windings such as overlapping windings or separated windings.

In one embodiment the liquid pervious polymer structure is a perforated structure, comprising one or more perforations allowing fluid to pass. The perforation may e.g. be in the form of slits that increase the flexibility of the flexible pipe, such as slits substantially perpendicular to the axis direction. Alternatively the perforations may be holes arranged with a selected distance e.g. in a desired pattern. The liquid pervious polymer structure provides that no pressure difference over the polymer structure is generated and thereby less static pressure is acting directly on the polymer structure. The static pressure is applied on the whole pressure armor.

In one embodiment the polymer structure comprises at least one tubular extruded layer. Such extruded layer is simple to apply, and if desired may be perforated after or during application.

In one embodiment the polymer structure is liquid impervious. The term “liquid impervious” is used to mean that substantially no liquid can pass over the polymer structure at a pressure difference up to at least 5 bars, preferably up to a pressure difference up to at least 10 bars. In practice an insignificant amount of liquid may pass the non-pervious polymer structure over time, however the amount of liquid passing the liquid impervious polymer structure should be kept sufficient low not to substantiate deteriorate the mechanical function of the pipe.

In one embodiment the polymer structure constitutes the inner sealing sheath. In this embodiment the polymer structure should be liquid impervious to prevent outflow from a liquid flowing in the bore of the flexible pipe.

In situations where the polymer structure constitutes the inner sealing sheath, it preferably has a thickness of at least about 4 mm.

The embodiment where the polymer structure constitutes the inner sealing sheath has the additional benefit that the polymer structure has two functions at the same time, namely an inner sealing function and a pressure armor function.

Thereby the total weight of the flexible pipe is additionally reduced and the strength to weight properties are even more advantageous.

In one embodiment the polymer structure constitutes an intermediate layer which may be liquid impervious or liquid pervious as described above.

In one embodiment the polymer structure constitutes an outer sealing sheath which is liquid impervious and arranged to prevent ingress of liquids.

In one embodiment the polymer structure constitutes an internal liquid pervious sheath. In this embodiment it is preferred that an additional pressure armor is arranged outside the inner sealing sheath. The additional armor may e.g. be in the form of one or more helically wound profiles and/or strips which may preferably be interlocked i.e. a locking between adjacent windings. The winding angle is preferably selected to be at least about 80 degree, such as between about 95 and about 90 degrees. The additional armor may be of one or more of the materials described herein for the strength imparting layers.

In one embodiment the polymer structure comprises as a wound structure of one or more films and/or one or more profiles. The polymer structure may e.g. be a multi layer bonded polymer structure comprising an extruded layer and a wound layer.

As mentioned above at least one of the first and the second strength imparting layers is a metal layer. In principle any metal can be used. Preferably the metal layer comprises one or more of the metals aluminum, titanium, and steel. In practice the most suitable material is steel. In one embodiment at least one of the first and the second strength imparting layers comprises steel e.g. duplex steel, stainless steel and carbon steel, more preferably at least one of the first and the second strength imparting layers is of steel.

In one embodiment at least one of the first and said second strength imparting layer is a metal layer.

In one embodiment the strength imparting layer (designated the first strength imparting layer) arranged closer to the axis than the other strength imparting layer (designated the second strength imparting layer) is a metal layer.

In one embodiment both of the first and said second strength imparting layer are metal layers.

Useful metal compositions for the strength imparting layer(s) which may be used separately or in any combinations comprise the steel material described in U.S. Pat. No. 5,407,744, the steel material described in U.S. Pat. No. 5,922,149, the steel material described in U.S. Pat. No. 6,291,079, the steel material described in U.S. Pat. No. 6,408,891, the steel material described in U.S. Pat. No. 6,904,939, the steel material described in U.S. Pat. No. 7,459,033, the steel material describe in WO 06097112, the steel material describe in U.S. Pat. No. 6,282,933 and the steel material describe in U.S. Pat. No. 6,408,891.

In one embodiment the flexible pipe comprises at least one strength imparting layer of a composite material comprising one or more polymers selected from thermoset polymers, cross-linked polymers and/or reinforced polymer, the reinforcement polymer preferably being reinforced with one or more of metals, such as metal powder and/or metal fibers; glass-fibers; carbon-fibers and/or aramide fibers. Preferred composite materials which may be used separately or in any combinations comprise the composite material described in U.S. Pat. No. 4,706,713, the composite material materials described in WO 05043020 and the composite materials described in WO 02095281.

In one embodiment a strength imparting layer of composite material constitutes one of the first and the second strength imparting layers, the strength imparting layer composite material preferably constituting the second strength imparting layer i.e. the strength imparting layer arranged most distant to the axis of the strength imparting layers.

In one embodiment both of the strength imparting layers are of composite materials which may be equal or different from each other in the respective layers.

In one embodiment at least one of the first and the second strength imparting layers is a helically wound element, such as a wound profile or a wound folded or non-folded strip.

The profiles and/or strips may be shaped as described in any one of described and shown in drawings in one or more of GB 1 404 394, U.S. Pat. No. 3,311,133, U.S. Pat. No. 3,687,169, U.S. Pat. No. 3,858,616, U.S. Pat. No. 4,549,581, U.S. Pat. No. 4,706,713, U.S. Pat. No. 5,213,637, U.S. Pat. No. 5,407,744, U.S. Pat. No. 5,601,893, U.S. Pat. No. 5,645,109, U.S. Pat. No. 5,669,420, U.S. Pat. No. 5,730,188, U.S. Pat. No. 5,730,188, U.S. Pat. No. 5,813,439, U.S. Pat. No. 5,837,083, U.S. Pat. No. 5,922,149, U.S. Pat. No. 6,016,847, U.S. Pat. No. 6,065,501, U.S. Pat. No. 6,145,546, U.S. Pat. No. 6,192,941, U.S. Pat. No. 6,253,793, U.S. Pat. No. 6,283,161, U.S. Pat. No. 6,291,079, U.S. Pat. No. 6,354,333, U.S. Pat. No. 6,382,681, U.S. Pat. No. 6,390,141, U.S. Pat. No. 6,408,891, U.S. Pat. No. 6,415,825, U.S. Pat. No. 6,454,897, U.S. Pat. No. 6,516,833, U.S. Pat. No. 6,668,867, U.S. Pat. No. 6,691,743, U.S. Pat. No. 6,739,355 U.S. Pat. No. 6,840,286, U.S. Pat. No. 6,889,717, U.S. Pat. No. 6,889,718, U.S. Pat. No. 6,904,939, U.S. Pat. No. 6,978,806, U.S. Pat. No. 6,981,526, U.S. Pat. No. 7,032,623, U.S. Pat. No. 7,311,123, U.S. Pat. No. 7,487,803, U.S. Pat. No. 23102044, WO 28025893, WO 2009024156, WO 2008077410 and WO 2008077409, optionally with one or more flanges and/or a pluralities of teeth e.g. as described further below, to engage with the polymer structure for providing a mechanical bonding or lock between the strength imparting layer and the polymer structure.

In one embodiment at least one of the first and the second strength imparting layers comprises annular windings with an angle to the axis which is at least about 80 degrees, such as at least about 85 degrees, such as up to about 90 degrees. The strength imparting layer may preferably have substantially identical winding angles sandwiching the polymer structure in between them.

In one embodiment at least one of the strength imparting layers is a helically wound element(s), such as at least one wound profile or wound folded or non-folded strip. The windings of the wound element may be interlocked or it may be non-interlocked. In one embodiment the windings of the consecutive windings are connected to each other by clips.

In one embodiment both of the strength imparting layers comprise at least one helically wound element. The at least one helically wound element may e.g. be in the form of one or more helically wound profiles and/or strips which may or may not be interlocked. The winding angle is preferably selected to be at least about 80 degree, such as between about 95 and about 90 degrees.

In one embodiment at least one of the first and the second strength imparting layers is a metal layer comprising at least one annular armoring member.

In one embodiment at least one of the first and the second strength imparting layers is a metal layer comprising a plurality of annular armoring members arranged along the length of the flexible pipe, the annular armoring members preferably being arranged side-by-side axially spaced from each other or at least partly in contacting relation with each other and/or in engagement and/or overlapping with each other. Such annular armoring members are e.g. described in DK PA 2009 01163.

In one embodiment the plurality of annular armoring members comprises at least a ring shaped armoring member, in the form of an endless ring shaped armoring member or an open ring shaped armoring member.

In one embodiment the plurality of annular armoring members arranged along the length of the flexible pipe is substantially identical with each other.

In one embodiment the plurality of annular armoring members arranged along the length of the flexible pipe comprises at least two different annular armoring members, the annular armoring members preferably differing from each other with respect to relative to one or more of their
annular shape;
cross-sectional profile;
axial width;
thickness;
stiffness;
material or materials;
mechanical strength;
chemical resistance, in particular towards aggressive gasses such as methane, hydrogen sulphides and/or carbon dioxides; and
corrosion resistance.

Further information about annular armoring members which may be used as one or more of the strength imparting layers can be found in DK PA 2009 01163.

In situations where the strength imparting layer is not the innermost layer and comprises annular armoring members, the annular armoring members may be provided in two or more sections which are mounted onto the pipe to form whole annular members or the annular armoring members may be formed from profiles and/or stripes with a length corresponding to the circumference of the annular armoring members and they may be folded around the pipe and welded to form whole annular armoring members. Other methods for forming the desired annular armoring members will be available for the skilled person.

The first and the second strength imparting layers respectively and individually from each other may preferably have a thickness of at least about 0.5 mm, such as at least about 1 mm, such as up to about 10 mm.

In general it is desired to keep the thickness of the strength imparting layer as low as possible to keep the weight low while simultaneously ensuring that the strength of the whole pressure armor layer is sufficient for the application of the flexible pipe.

As mentioned above the first and the second strength imparting layers respectively and individually from each other are locked or bonded to the polymer structure.

In one embodiment the first and the second strength imparting layers respectively and individually from each other are chemically and/or mechanically locked or bonded to the polymer structure. Methods of chemically bonding layers to each other are known from the art of bonded pipes, and these methods may be employed in the present invention, provided that they are applied prior to arranging the tensile layer(s) to ensure that the tensile layer(s) are not bonded but capable of moving in an least substantial circumferential direction, preferably it will be capable of moving in several directions including substantial circumferential direction relative to the pressure armor.

In one embodiment the first and/or the second strength imparting layer(s) of metal comprise a precursor through which the strength imparting layer(s) is chemically bonded to the polymer structure.

The mechanical lock may for example be provided with one or more flanges and/or a plurality of teeth arranged on the strength imparting layer(s) and protruding towards the polymer structure. Useful examples are shown in the figures.

In one embodiment at least one of the first and the second strength imparting layers is mechanically locked to the polymer structure in substantial circumferential direction, such that the at least one strength imparting layer(s) cannot move in substantial circumferential direction relative to the polymer structure. However, the strength imparting layers may still move relative to the polymer structure in axial direction e.g. if the flexible pipe is bended, the element(s) of the strength imparting layers can move in axial direction relative to the polymer structure to follow the polymer structure in the bend of the flexible pipe.

In one embodiment at least one of the first and the second strength imparting layers comprises annular windings of at least one profiled wire with an angle to the axis which is at least about 80 degrees, the at least one profiled wire comprising one or more flanges arranged to lock the at least one strength imparting layer(s) to the polymer substrate to prevent relative circumferential movement there between.

The protruding flange may be arranged to have a length with a length direction substantially perpendicular to the circumferential direction of the flexible pipe. If the strength imparting layer(s) comprises a folded, helically wound strip the flange may for example be made as a fold. If the strength imparting layer(s) comprises a helically wound profile the flange may for example be made as an extruded flange, which may be twisted to have a length direction substantially perpendicular to the circumferential direction or the a plurality of flanges may be made immediately after the profile exit the extruder and prior to it being cooled, e.g. by using a suitably tool for making the flanges with a length direction substantially perpendicular to the length direction of the extruded profile.

In one embodiment a plurality of flanges may be mounted to the profile prior to winding it. Such mounted flanges may e.g. be mounted by welding, gluing or by mechanical means. The plurality of flanges may preferably be mounted to have a length direction substantially perpendicular to the length direction of the profile.

In embodiments comprising teeth, such teeth may be provided by equivalent methods as the method for providing a plurality of flanges.

In one embodiment the first and/or the second strength imparting layer(s) of metal comprises one or more protruding flanges and/or teeth arranged to engage with the polymer structure to thereby provide a mechanical bonding to the polymer structure.

The flange(s) and or teeth should preferably protrude towards the polymer structure e.g. with an angle of about 90 degrees +/− up to about 45 degrees, preferably with an angle of about 90 degrees +/− up to about 30 degrees.

The flange(s) and or teeth should preferably protrude to a sufficient degree and be sufficiently sharp to make a resistance against relative movement between the strength imparting layer and the polymer structure in at least one direction.

The flange(s) and or teeth should preferably protrude partly into the polymer structure such that the polymer structure will be slightly deformed without resulting in cracks or cuts in the polymer structure.

### BRIEF DESCRIPTION OF DRAWINGS

The invention will be explained more fully below in connection with a preferred embodiment and with reference to the drawings in which:

FIG. 1 is a schematic side view of a flexible pipe of the invention with a tensile armor and a pressure armor where the polymer substrate constitutes an intermediate layer.

FIG. 2 is a schematic side view of a flexible pipe of the invention with a tensile armor and a pressure armor where the polymer substrate constitutes the inner sealing sheath.

FIG. 3 is a schematic side view of a flexible pipe of the invention with a tensile armor and a pressure armor where the polymer substrate constitutes an outer sealing sheath.

FIG. 4 is a schematic side view of a flexible pipe of the invention with a tensile armor and two pressure armors where the polymer substrate constitutes an internal liquid permeable sheath.

FIGS. 5-8 are cross sectional side views of different pressure armors of flexible pipes of the invention.

FIG. 8a is a perspective view of a flange similar to the flanges mounted on a strength imparting layer of the flexible pipe of FIG. 8.

The figures are schematic and may be simplified for clarity. Throughout the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

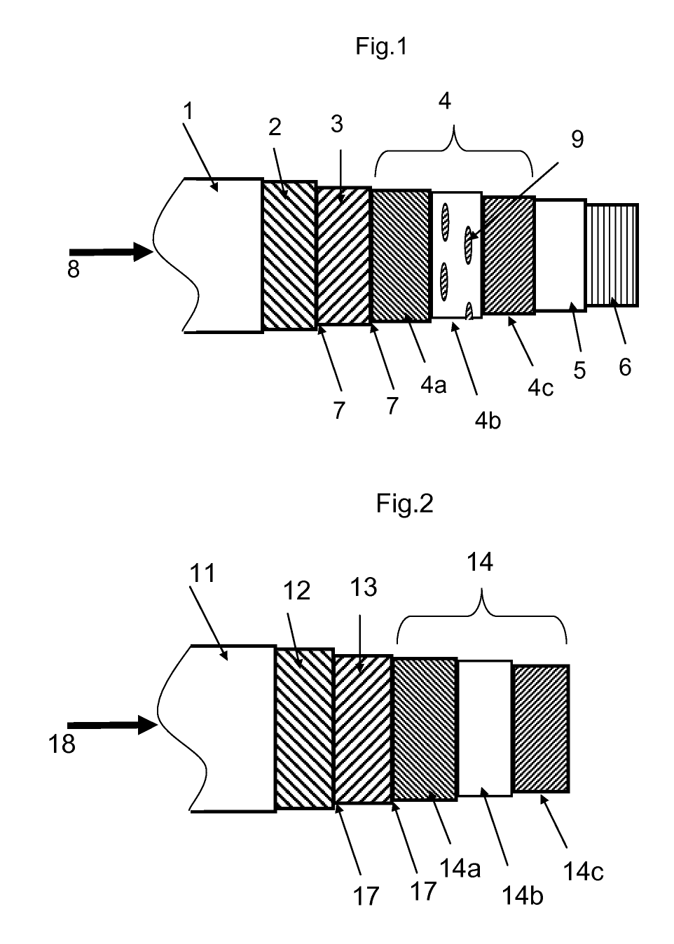

The flexible pipe shown in FIG. 1 comprises an inner sealing sheath 5, often also called an inner liner, e.g. of cross linked polyethylene (PEX), polyimide (PA-11, PA 12) PVDF as well as other flour containing polymers and as described above. Inside the inner sealing sheath 5 the pipe comprises an inner armoring 6 called a carcass. On the outer side of the inner sealing sheath 5, the flexible pipe comprises a pressure armor 4 with a sandwich structure, two layers of tensile armor 2, 3 and an outer sealing sheath 1 for mechanical protection and arranged to prevent ingress of water when used in off-shore applications.

The tensile armoring layers 2, 3 may for example be cross wound and made from wound profiles and/or strips, wherein the tensile armoring layers have angle to the axis of about 55 degrees or less. In an alternative embodiment at least one of the layers 2, 3 is a tensile armoring layer, for example one of the armoring layers 2 has an angle above 55 degrees, typically between 60 and 75 degrees, and the other one of the armoring layers 3 has an angle below 55 degrees, typically between 30 and 45 degrees.

Between respectively the two tensile armors 2, 3 and the innermost tensile armor 3 and the pressure armor 4 is arranged an anti-wear layer for reducing wear when the armor layers 2, 3, 4 move relative to each other.

The pressure armor 4 with a sandwich structure comprises a first and a second strength imparting layer 4a, 4c arranged on either side and locked or bonded to a polymer structure 4b. The polymer structure in the embodiment shown in FIG. 1 is an intermediate polymer structure 4b comprising slits arranged to increase the flexibility of the flexible pipe as compared to the flexibility of a similar flexible pipe with an intermediate polymer structure 4b which does not have such slits. The slits are arranged with their length direction substantially perpendicular to the axial direction of the pipe. The strength imparting layers may for example be as described above and/or as described in the examples below and shown in the figures.

The flexible pipe may have fewer or more layers than the pipe of FIG. 1, for example the pipe may have additional layers such as an insulation layer, additional protection layers and the carcass may e.g. be omitted.

The layers may e.g. be of materials as described above and/or of materials as usually employed in flexible pipes.

The flexible pipe of FIG. 2 comprises a pressure armor 14 with a sandwich structure, two layers of tensile armor 12, 13 and an outer sealing sheath 11 for mechanical protection and arranged to prevent ingress of water when used in off-shore applications.

The tensile armoring layers 12, 13 may for example be as described above.

Between respectively the two tensile armors 12, 13 and the innermost tensile armor 13 and the pressure armor 14 is arranged an anti-wear layer for reducing wear when the armor layers 12, 13, 14 move relative to each other.

The pressure armor 14 with a sandwich structure comprises a first and a second strength imparting layer 14a, 14c arranged on either side and locked or bonded to a polymer structure 14b. The polymer structure 14b in the embodiment shown in FIG. 2 constitutes the inner sealing sheath of the pipe. The polymer structure 14b arranged as inner sealing sheath will typically be at least slightly thicker, such as from about 110% to about 200% thicker than an inner sealing sheath of a prior art flexible pipe having comparable bore diameter. The polymer structure 14b seals against outflow of fluid flowing in the bore of the pipe.

The flexible pipe may have additional layers if desired for the given application of the flexible pipe.

The layers may e.g. be of materials as described above and/or of materials as usually employed in flexible pipes.

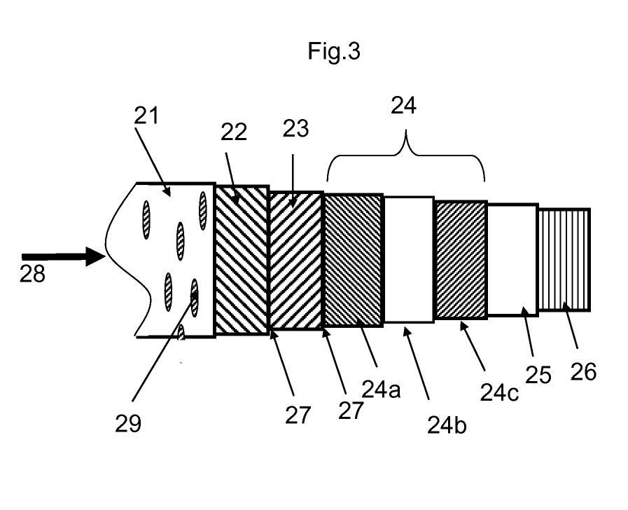

The flexible pipe of FIG. 3 comprises an inner sealing sheath 25, often also called an inner liner, e.g. of cross linked polyethylene (PEX), polyamide (PA-11, PA 12) PVDF as well as other flour containing polymers and as described above. Inside the inner sealing sheath 25 the pipe comprises an inner armoring 26, called a carcass. On the outer side of the inner sealing sheath 25, the flexible pipe comprises a pressure armor 24 with a sandwich structure, two layers of tensile armor 22, 23 and an outer liquid permeable protecting sheath 21 for mechanical protection of the flexible pipe. The outer sheath 21 comprises slits arranged with their length direction substantially perpendicular to the axial direction of the pipe. Other methods for making the outer sheath liquid permeable will be available to the skilled person and include i.a. a wound outer sealing and or a textile outer sealing and other.

The tensile armoring layers 22, 23 may for example be as described above.

Between respectively the two tensile armors 22, 23 and the innermost tensile armor 23 and the pressure armor 24 is arranged an anti-wear layer for reducing wear when the armor layers 22, 23, 24 move relative to each other.

The pressure armor 24 with a sandwich structure comprises a first and a second strength imparting layer 24a, 24c arranged on either side and locked or bonded to a polymer structure 24b. The polymer structure in the embodiment shown in FIG. 3 is an outer sealing sheath protecting against ingress of water to one of the strength imparting layers 24c.

The strength imparting layers may for example be as described above and/or as described in the examples below and shown in the figures.

The flexible pipe may have fewer or more layers than the pipe of FIG. 3, for example the pipe may have additional layers such as an insulation layer, additional protection layers and the carcass may e.g. be omitted.

The layers may e.g. be of materials as described above and/or of materials as usually employed in flexible pipes. In one embodiment of FIG. 3 the flexible pipe may be intended to carry fluid under pressure, which fluid comprises H₂ S. The tensile armor layers and the strength imparting layers are of or comprise steel. The steel of the innermost strength imparting layer 24c of the flexible pipe is a steel meeting H₂ S resistance criteria, and the steel of one or more of the other one of the strength imparting layers 24a and of the tensile layers is steel having a lower corrosion resistance against H₂ S e.g. steel that does not meet H₂ S resistance criteria.

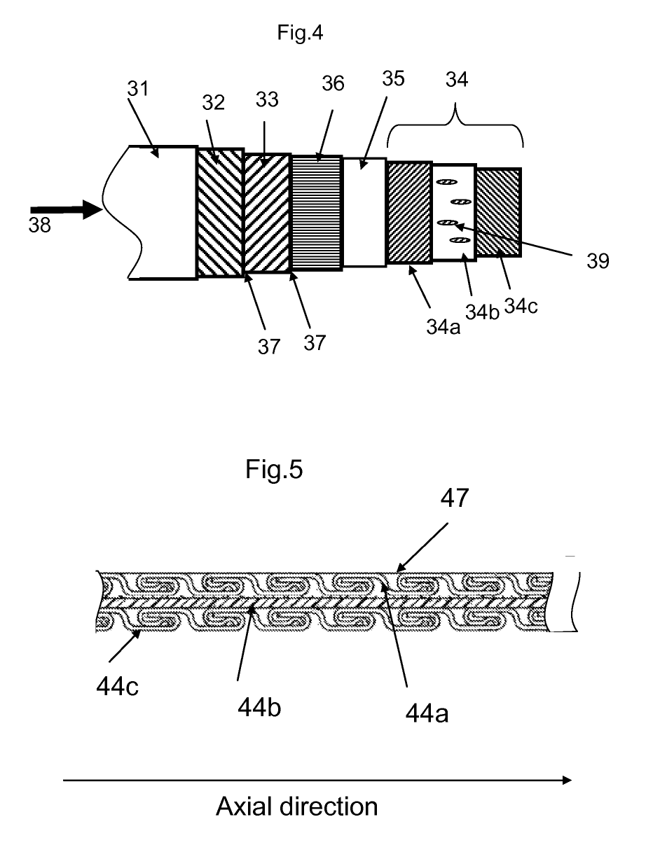

The flexible pipe of FIG. 4 comprises an inner sealing sheath 35, e.g. of cross linked polyethylene (PEX), polyamide (PA-11, PA 12) PVDF as well as other flour containing polymers and as described above. Inside the inner sealing sheath 35 the pipe comprises a pressure armor 34 with a sandwich structure comprises a first and a second strength imparting layer 34a, 34c arranged on either side and locked or bonded to a polymer structure 34b. The polymer structure in the embodiment shown in FIG. 4 is an internal liquid permeable sheath comprising slits arranged with their length direction substantially in the axial direction of the pipe. Other methods for making the internal liquid permeable sheath liquid permeable will be available to the skilled person and include i.a. a wound internal liquid permeable sheath and or a textile internal liquid permeable sheath and other. The internal liquid permeable sheath and the inner most strength imparting layer 34c may preferably be shaped with a view to minimizing turbulence within the bore.

The strength imparting layers may for example be as described above and/or as described in the examples below and shown in the figures.

On the outer side of the inner sealing sheath 35, the flexible pipe comprises an additional pressure armor 36 e.g. in the form of a helically wound and optionally interlocked profile. Further more the flexible pipe comprises two layers of tensile armor 32, 33 and an outer sealing sheath 31 protecting the pipe against ingress of water.

The tensile armoring layers 22, 23 may for example be as described above.

Between respectively the two tensile armors 22, 23 and the innermost tensile armor 23 and the additional pressure armor 36 is arranged an anti-wear layer for reducing wear when the armor layers 32, 33, 36 move relative to each other.

The flexible pipe may have fewer or more layers than the pipe of FIG. 4, for example the pipe may have additional layers such as an insulation layer, additional protection layers and intermediate layers.

The layers may e.g. be of materials as described above and/or of materials as usually employed in flexible pipes.

FIG. 5 is a cross sectional side view of a pressure armor of a flexible pipe of the invention. Only the pressure armor and an anti-wear layer 47 are shown. The flexible pipe may for example comprise a not shown tensile armor layer applied upon the anti-wear layer 47.

The pressure armor comprises a first and a second strength imparting layer 44a, 44c sandwiched around a polymer structure 44b. The strength imparting layers 44a, 44c are bonded to the polymer structure 44b e.g. by applying heat and optionally pressure to the sandwiched layer prior to application of one or more tensile armor layers. The strength imparting layers 44a, 44c are made from folded, helically wound and interlocked strips of a metal. The arrow indicates the axial direction.

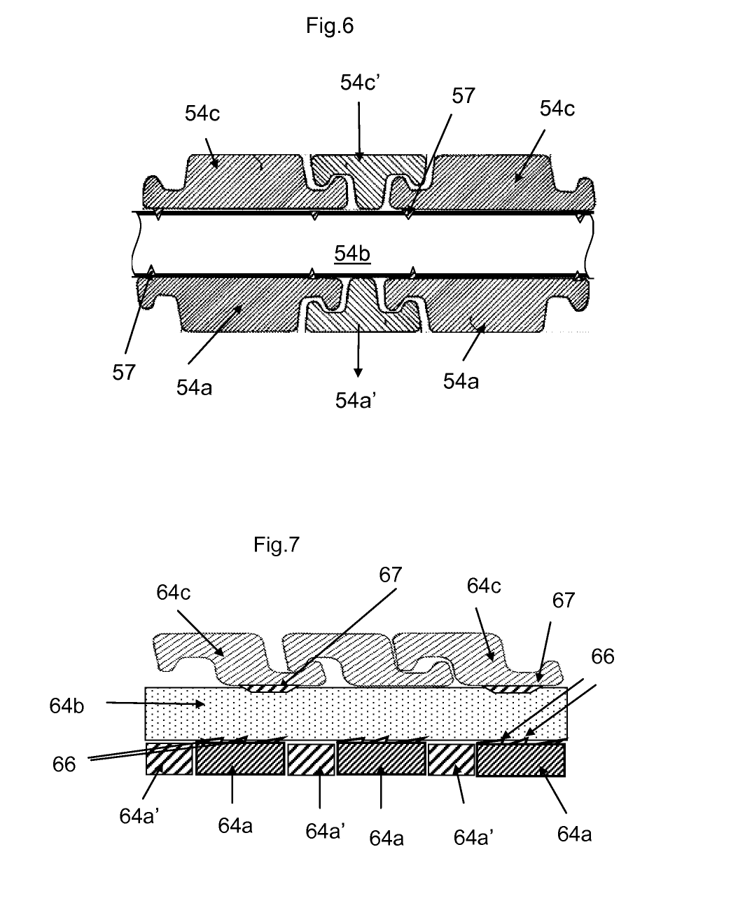

FIG. 6 is a cross sectional side view of a pressure armor of a flexible pipe of the invention. Only the pressure armor is shown.

The pressure armor comprises a first and a second strength imparting layer 54a, 54a′, 54c, 54c′ sandwiched around a polymer structure 54b. The strength imparting layers 54a, 54a′, 54c, 54c′are locked to the polymer structure 54b by teeth 56 protruding from the strength imparting layers 54a, 54a′, 54c, 54c′ towards and slightly into the polymer structure 44b to deform the polymer structure 44b. The teeth are arranged such that relative movement in substantial circumferential direction is substantially prevented. However, the teeth may be shaped such to allow the strength imparting layers 54a, 54a′, 54c, 54c′ to move at least slightly relative to the polymer structure 54b in axial direction e.g. if the flexible pipe is bended, the element(s) of the strength imparting layers 54a, 54a′, 54c, 54c′ can move in axial direction relative to the polymer structure to follow the polymer structure 54b in the bend of the flexible pipe.

The strength imparting layers 54a, 54a′, 54c, 54c′ are made from helically wound and interlocked T-shaped profiles optionally of a polymer and/or metal. The T-shaped profiles may e.g. be helically wound for example with a winding degree of about 80 to about 90 degrees and/or the T-shaped profiles may be annular armoring members as described above.

FIG. 7 is a cross sectional side view of a pressure armor of a flexible pipe of the invention. Only the pressure armor is shown.

The pressure armor comprises a first and a second strength imparting layer 64a, 64a′, 64c sandwiched around a polymer structure 64b. The strength imparting layers 64a, 64a′, 64c are locked to the polymer structure 64b by flanges 67 and teeth 66 protruding from the respective strength imparting layers 64a, 64a′, 64c towards and slightly into the polymer structure 64b to deform the polymer structure 54b and thereby locking or bonding the respective strength imparting layers 64a, 64a′, 64c to the polymer structure 64b. The teeth and flanges are arranged such that relative movement in circumferential direction is substantially prevented, thereby servicing firm mechanical coupling. However at least the second strength imparting layer 64c may still move relative to the polymer structure 64b in axial direction e.g. if the flexible pipe is bended, the element(s) of the strength imparting layer 64c can move in axial direction relative to the polymer structure 64b to follow the polymer structure in the bend of the flexible pipe.

The strength imparting layers 64a, 64a′, 64c are made from respectively helically wound and interlocked Z-shaped profiles and—except from the teeth—of substantially square profiles of polymer and/or metal. The flanges 67 arranged on the second strength imparting layer 64c, are arranged at desired distances on and along the length of the Z-shaped profiles with a length direction substantially perpendicular to the length direction of the Z-shaped profiles and substantially perpendicular to the circumferential direction. The flanges 67 may be provided as described above.

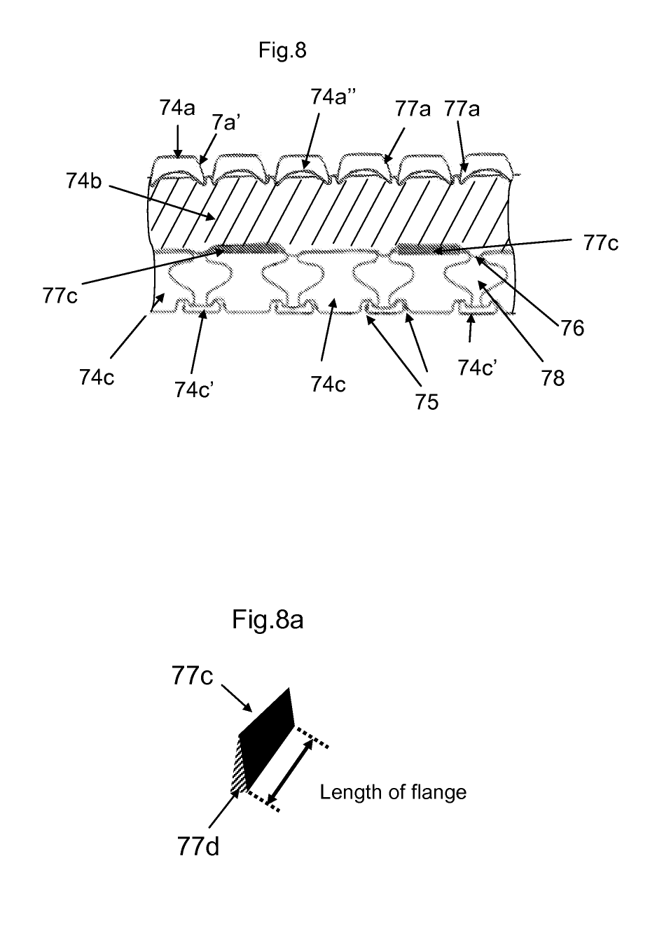

FIG. 8 is a cross sectional side view of a pressure armor of a flexible pipe of the invention. Only the pressure armor is shown.

The pressure armor comprises a first and a second strength imparting layer 74a, 74c, 74c′ sandwiched around a polymer structure 74b. The first strength imparting layers 74a, is mechanical bonded to the polymer structure 74b by flanges 77a protruding from the first strength imparting layer 74a, towards and pressing into the polymer structure 74b to deform the polymer structure 74b to such a degree that a firm mechanical bonding is provided. The second strength imparting layer 74c, 74c′ is mechanical locked to the polymer structure 74b by flanges 77c protruding from the second strength imparting layer 74c, 74c′ towards and slightly into the polymer structure 74b to slightly deform the polymer structure 74b. The flanges 77c protruding from the second strength imparting layer 74c, 74c′ are arranged such that relative movement in circumferential direction between the second strength imparting layer 74c, 74c′ and the polymer structure 74b is substantially prevented. However, the second strength imparting layer 74c, 74c′ may still move relative to the polymer structure 74b in axial direction e.g. if the flexible pipe is bended, the element(s) of the strength imparting layer 74c, 74c′ can move in axial direction relative to the polymer structure 74b to follow the polymer structure in the bend of the flexible pipe.

The strength imparting layers 74a, 74c, 74c′ are made from respectively helically wound I-shaped profile(s) 74c interlocked by helically wound C-profiles 74c′, and non-interlocked C-curved profile(s) of polymer and/or metal.

The flanges 77c arranged on the second strength imparting layer 74c, 74c′, are arranged at desired distances on and along the length of the I-shaped profile(s) with a length direction substantially perpendicular to the length direction of the Z-shaped profile(s) and substantially perpendicular to the circumferential direction.

The flanges 77c may be provided as described above.

The I-C interlocked strength imparting layer 74c, 74c′ comprises plays 75, 76 such that the respective windings of the helically wound I-shaped profile(s) can move slightly with respect to adjacent interlocked windings. Depending on the material of the polymer structure 74b, it may be pressed slightly into the play 76 facing the polymer structure 74b.

The I-C interlocked strength imparting layer 74c, 74c′ comprises interspaces free of material which adds to obtaining a high inertia while simultaneously keeping the weight as low as possible.

In FIG. 8a a flange 77c similar to the flanges mounted on the imparting layer 74c, 74c′ as shown in FIG. 8 is shown. The flange is shaped as a ridge with a triangular cross sectional shape having a base side 77d and a length as shown in FIG. 8a. The ridge is mounted to the I-shaped profile with its base side facing the I-shaped profile and glued or welded thereto or fixed by any other method. The skilled person will understand that the flange may have other shapes than the shown.

What is claimed is:

1. A flexible pipe having a length and comprising a tubular inner sealing sheath surrounding an axis and defining a bore, said flexible pipe comprises at least one pressure armor and at least one tensile armor comprising one or more layers, said pressure armor and said tensile armor being non-bonded relative to each other, said pressure armor comprises a sandwich structure comprising a polymer structure and a first and a second strength imparting layer arranged on either side of said polymer structure and locked or bonded to said polymer structure.

2. A flexible pipe as claimed in claim 1, wherein said polymer structure is substantially uniform along the length of the pipe.

3. A flexible pipe as claimed in claim 1, wherein said polymer structure varies along the length of the pipe.

4. A flexible pipe as claimed in claim 1, wherein said polymer structure comprises a multi-layer bonded polymer structure comprising at least 2 bonded layers.

5. A flexible pipe as claimed in claim 4, wherein said polymer structure comprises at least one film layer with a thickness of from about 25 μm to about 1 mm.

6. A flexible pipe as claimed in claim 1, wherein said polymer structure has a total thickness of at least about 2 mm.

7. A flexible pipe as claimed in claim 1, wherein said polymer structure comprises one or more of the materials selected from polyolefins; polyamide; polyimide (PI); polyurethanes; polyureas; polyesters; polyacetals; polyethers; polyoxides; polysulfides; polysulphones; polyacrylates; polyethylene terephthalate (PET); polyether-ether-ketones (PEEK); polyvinyls; polyacrylonitrils; polyetherketoneketone (PEKK); copolymers of the preceding; fluorous polymers; compounds comprising one or more of the above mentioned polymers, or composite materials compounded with reinforcement fibers.

8. A flexible pipe as claimed in claim 1, wherein said polymer structure is liquid pervious.

9. A flexible pipe as claimed in claim 8, wherein said polymer structure is a wound structure.

10. A flexible pipe as claimed in claim 8, wherein said polymer structure is a perforated structure comprising one or more perforations allowing fluid to pass.

11. A flexible pipe as claimed in claim 1, wherein said polymer structure comprises at least one tubular extruded layer.

12. A flexible pipe as claimed in claim 11, wherein said polymer structure is liquid impervious.

13. A flexible pipe as claimed in claim 11, wherein said polymer structure constitutes the inner sealing sheath.

14. A flexible pipe as claimed in claim 1, wherein said polymer structure constitutes an intermediate layer.

15. A flexible pipe as claimed in claim 1, wherein said polymer structure constitutes an outer sealing sheath preventing ingress of liquids.

16. A flexible pipe as claimed in claim 1, wherein said polymer structure constitutes an internal liquid permeable sheath.

17. A flexible pipe as claimed in claim 1, wherein at least one of said first and said second strength imparting layers is a metal layer comprising or consisting essentially of metal.

18. A flexible pipe as claimed in claim 1, wherein said first strength imparting layer is arranged closer to the axis than said second strength imparting layer.

19. (canceled)

20. A flexible pipe as claimed in claim 1, wherein at least one of said strength imparting layers is/are of composite material comprising one or more polymers selected from thermoset polymers, cross-linked polymers or reinforced polymer, reinforced with at least one of metals; glass-fibers; carbon-fibers aramide fibers.

21. (canceled)

22. A flexible pipe as claimed in claim 1, wherein at least one of said first and said second strength imparting layers comprises a helically wound element.

23. A flexible pipe as claimed in claim 1, wherein at least one of said first and said second strength imparting layers comprises annular windings with an angle to the axis which is at least about 80 degrees.

24. A flexible pipe as claimed in claim 1, wherein at least one of said first and said second strength imparting layers is a metal layer comprising at least one annular armoring member.

25. A flexible pipe as claimed in claim 22 wherein said annular armoring member is a helically wound element.

26. A flexible pipe as claimed in claim 23, wherein at least one of said first and said second strength imparting layers is a metal layer comprising a plurality of annular armoring members arranged along the length of the flexible pipe.

27-29. (canceled)

30. A flexible pipe as claimed in claim 1, wherein said first and said second strength imparting layers respectively and individually from each other have a thickness of at least about 0.5 mm.

31. A flexible pipe as claimed in claim 1, wherein said first and said second strength imparting layers respectively and individually from each other are chemically and/or mechanically locked or bonded to the polymer structure.

32. A flexible pipe as claimed in claim 1, wherein at least one of said first and said second strength imparting layers is mechanical locked to said polymer structure in circumferential direction, such that said at least one strength imparting layer(s) cannot move in substantial circumferential direction relative to said polymer structure.

33. A flexible pipe as claimed in claim 1, wherein at least one of said first and said second strength imparting layers comprises annular windings of at least one profiled wire with an angle to the axis which is at least about 80 degrees, said at least one profiled wire comprising one or more flanges arranged to lock said at least one strength imparting layer(s) to said polymer substrate to prevent relative circumferential movement there between.

34. A flexible pipe as claimed in claim 1, wherein said first and/or said second strength imparting layer(s) of metal comprise one or more protruding flanges and/or teeth arranged to engage with the polymer structure to thereby provide a mechanical bonding to the polymer structure.

35. (canceled)
